(19) United States
(12) Patent Application Publication
(10) Pub. No.: US 2016/0049222 A1
(43) Pub. Date: Feb. 18, 2016

(54) Flexible Transmission Line Assembly

(71) Applicant: Honor Gene Co., Ltd., New Taipei City (TW)

(72) Inventor: Zhi Xin Zhou, New Taipei City (TW)

(21) Appl. No.: 14/491,803

(22) Filed: Sep. 19, 2014

(30) Foreign Application Priority Data
Aug. 13, 2014 (TW) 103214348

(51) Int. Cl. H01B 7/24; H01B 3/30

(52) U.S. Cl. CPC H01B 7/24; H01B 3/302; H01B 3/307

(57) ABSTRACT

A flexible transmission line assembly, which is connected between two relatively moving means that are movable relative to each other, comprises an abrasion-resistant flexible film and a plurality of transmission lines. The abrasion-resistant flexible film inner surface is surrounded to form a receiving space and is provided with an adhesive. The plurality of transmission lines is provided within the receiving space in a way each transmission line is adjacent to one another in a single row in width directions of the transmission lines, and the adjacent transmission lines being closely contacted with each other. The plurality of transmission lines is adhered with the inner surface of the abrasion-resistant flexible film by means of the adhesive, and the plurality of transmission lines at both ends in a longitudinal direction thereof is formed with a connecting element.

### FIELD OF THE INVENTION

The present invention relates to a transmission line assembly, and more particularly, to a flexible transmission line assembly connected between two moving means that are movable relative to each other.

### BACKGROUND OF THE INVENTION

Conventional transmission line assembly includes a plurality of transmission lines connected between two moving means that are movable relative to each other and a towline that is for protecting the plurality of transmission lines. The towline comprises front and rear ends which link to a plurality of hinge joints in a mutually bendable manner. One end of the towline is mounted on a movable means, and the other end of the towline is mounted on a fixed means or on a floor. An interior of each hinge joint has an accommodating space for the flexible transmission lines to be accommodated therein.

However, the cost of the conventional transmission line assembly is proportional to the number of hinge joints. The greater the amount of hinge joints, the higher the purchase costs. In addition, a large storage space is required to accommodate the bulky towlines while they are not in use. Further, a steel towline produces high-decibel noise while in motion whereas a plastic towline and its transmission lines are prone to be mutually abraded, which will also cause dust pollution to the environment.

### SUMMARY OF THE INVENTION

In view of this, the present invention provides a flexible transmission line assembly which is connected between two moving means that are movable relative to each other. In comparison with the conventional transmission line assemblies, the flexible transmission line assembly provided by the present invention has various advantages, such as low cost, lightweight, non-occupation of space and freedom from noise pollution as well as dust pollution during reciprocation.

The present invention utilizing a flexible transmission line assembly, which is connected between two moving means that are movable relative to each other to solve the issue in the conventional art, comprises:

an abrasion-resistant flexible film, wherein an accommodating space is formed by encirclement of an inner surface, and an adhesive disposed on the inner surface thereon; and

a plurality of transmission lines disposed within the accommodating space and aligned in parallel with each other in a single row in a width direction, wherein each adjacent transmission line is closely contacted with one another, said plurality of transmission lines being adhered to the inner surface of the abrasion-resistant flexible film by means of the adhesive, and a connecting element formed respectively at the two ends of said plurality of transmission lines in a longitudinal direction thereof.

Another object of the present invention is to provide a flexible transmission line assembly, wherein the abrasion-resistant flexible film is an abrasion-resistant flexible sheet coated on outer surfaces of the plurality of transmission lines.

Another object of the present invention is to provide a flexible transmission line assembly, wherein an overlapping portion lies where two edge portions of the abrasion-resistant flexible film extend outward along a width direction of said plurality of transmission lines; the two overlapping portions being overlapped with each other and the overlapping portion being adhesively fixed on the other overlapping portion.

Another object of the present invention is to provide a flexible transmission line assembly, wherein the abrasion-resistant flexible film is made up of two abrasion-resistant flexible sheets coated on the outer surfaces of the plurality of transmission lines.

Another object of the present invention is to provide a flexible transmission line assembly, wherein an overlapping portion lies where two edge portions of each abrasion-resistant flexible sheet extend outward along a width direction of the transmission lines, and said overlapping portions each being adhesively fixed on the overlapping portions of another abrasion-resistant flexible sheet.

Another object of the present invention is to provide a flexible transmission line assembly, wherein an inner surface of the overlapping portion is adhered to an inner surface of the other overlapping portion by the adhesive.

Another object of the present invention is to provide a flexible transmission line assembly, wherein the abrasion-resistant flexible film is provided with a coating portion which is partially adhered to an outer surface of the plurality of transmission lines and a gap is formed in a non-bonded portion between the coating portion and a the plurality of transmission lines.

Another object of the present invention is to provide a flexible transmission line assembly, wherein the abrasion-resistant flexible film is provided with a coating portion completely adhered to an outer surface of the plurality of transmission lines to completely discharge gas within the accommodating space.

Another object of the present invention is to provide a flexible transmission line assembly, wherein the abrasion-resistant flexible film can be made of PU (Poly Urethane), TPFE (Poly Tetra Flouro Ethene), or PET (Polyethylene terephthalate).

Another object of the present invention is to provide a flexible transmission line assembly, wherein the adhesive can be a silicon adhesive or an acrylic adhesive.

With the characteristic features as above, the abrasion-resistant flexible film has a lower price, which saves the setup costs of the flexible transmission line assembly. In addition, since the flexible transmission line assembly is lightweight, it can be easily disposed on two moving means that are movable relative to each other. Moreover, since the abrasion-resistant flexible film of the flexible transmission line assembly is a thin piece, storage is convenient apart from non-occupation of the storage space. Further, there will not be an abrasive action between the abrasion-resistant flexible film and the transmission lines when the flexible transmission line assembly is used in the two moving means that are movable relative to each other because the abrasion-resistant flexible film is tightly coated on the plurality of transmission lines.

### BRIEF DESCRIPTION OF THE DRAWINGS

The structure and the technical means adopted by the present invention to achieve the above and other objectives can be best understood by referring to the following detailed description of the preferred embodiments and the accompanying drawings.

FIG. 1 is a stereogram illustrating a flexible transmission line assembly according to an embodiment of the present invention;

FIG. 2 is a sectional view illustrating the flexible transmission line assembly according to the embodiment of the present invention;

FIG. 3 is a schematic view illustrating application of two moving means that are movable relative to each other to the flexible transmission line assembly according to the embodiment of the present invention;

FIG. 4 is stereogram illustrating a flexible transmission line assembly according to another embodiment of the present invention; and

FIG. 5 is a sectional view illustrating the flexible transmission line assembly according to the embodiment of the present invention.

### DETAILED DESCRIPTION OF THE PREFERRED EMBODIMENTS

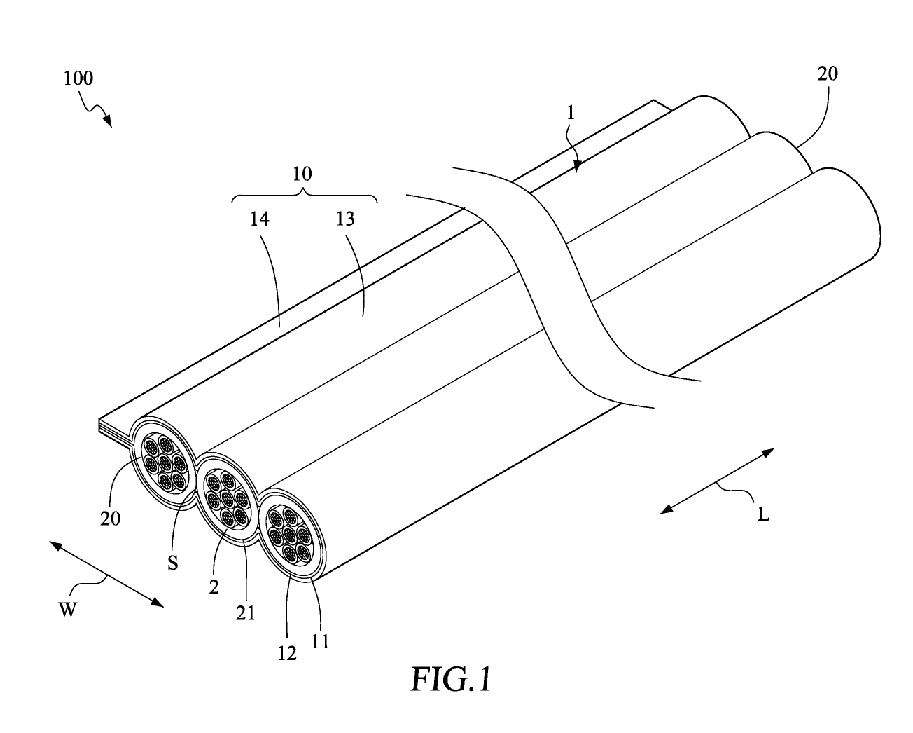

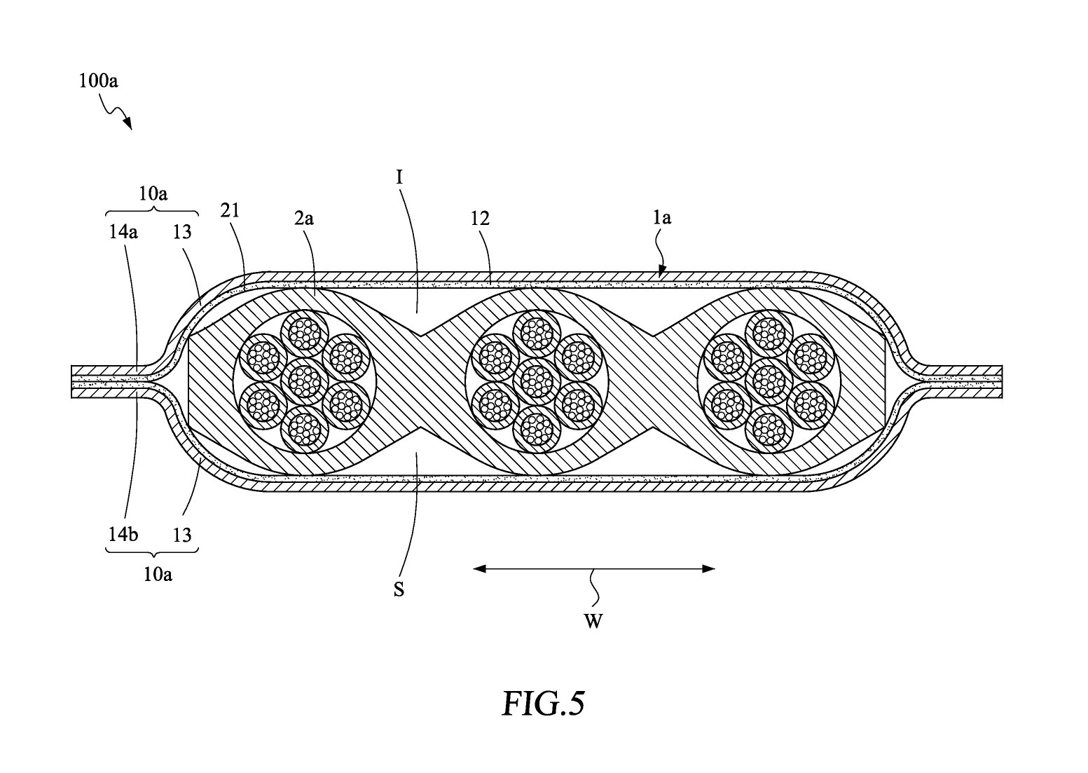

Embodiments are described in detail below with reference to the FIGS. 1 to 5, and the description is used for explaining the embodiments of the present invention only, but not intended to limit the described embodiments of the present invention.

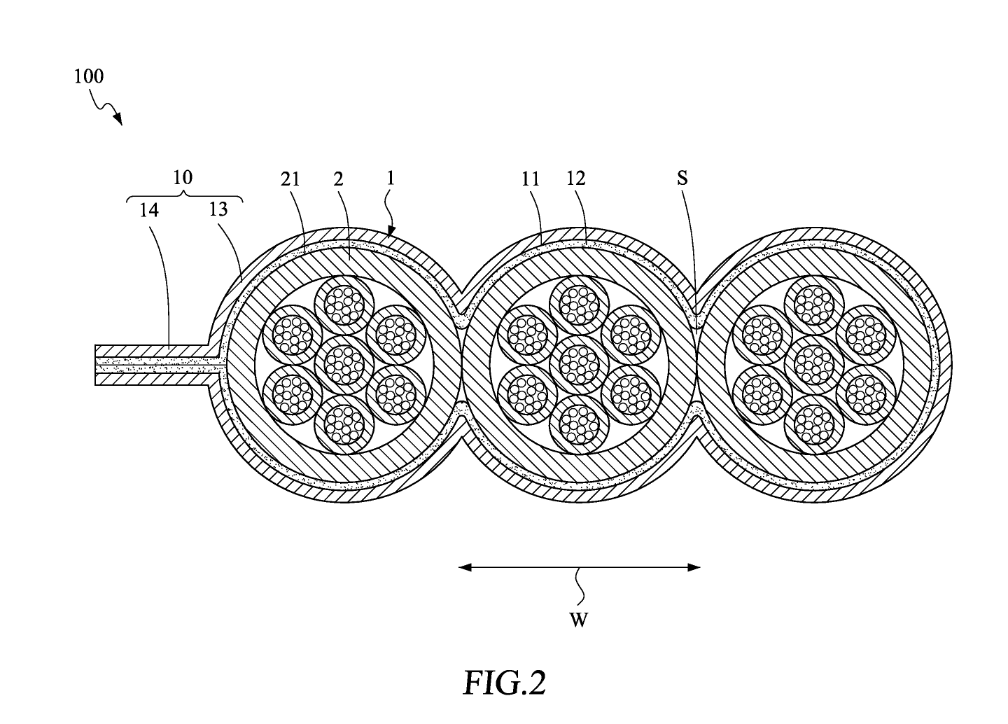

Referring to FIGS. 1 and 2, a flexible transmission line assembly 100 according to one embodiment of the present invention includes an abrasion-resistant flexible film 1 and three transmission lines 2.

The abrasion-resistant flexible film 1 has favorable flexibility and abrasion resistance. For example, the abrasion-resistant flexible film 1 can be made of PU (Poly Urethane), TPFE (Poly Tetra Flouro Ethene), PET (Polyethylene terephthalate) or the like. An accommodating space S is formed by encirclement of an inner surface 11 of the abrasion-resistant flexible film 1 and an adhesive 12 is disposed on the inner surface 11. The adhesive 12 can be a silicon adhesive, an acrylic adhesive or the like.

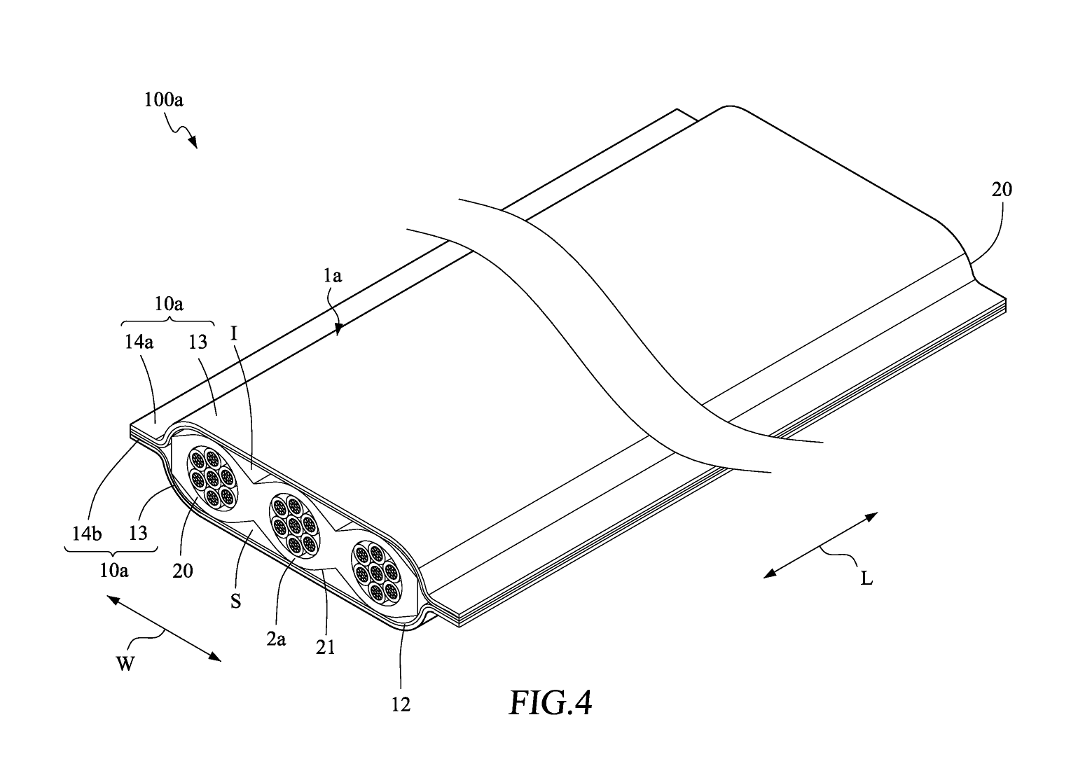

In the present embodiment, the transmission lines 2 are multi-core wires, and outer diameters have the same length. However, in other embodiments, transmission lines 1 can be single-core wires, or may be a combination of single-core wires and multi-core wires. In another embodiment of the present invention, the transmission lines 2a are flat-configuration multi-core wires (as shown in FIG. 4). Furthermore, the outer diameters of the transmission lines 2a can have mutually different length. The transmission lines 2 are aligned in parallel with each other in a single row in a width direction W and disposed within an accommodating space S. The transmission lines 2 each is adjacent to one another and closely contacted with one another. The transmission lines 2 are adhered to the inner surface 11 of the abrasion-resistant flexible film 1 by means of the adhesive 12. A connecting element 20 is formed respectively at the two ends of said plurality of transmission lines in a longitudinal direction L thereof, and the connecting elements 20 are respectively connected to the two control means 300.

In the present embodiment, the abrasion-resistant flexible film 1 is made up of an abrasion-resistant flexible sheet 10 coated on outer surfaces 21 of the transmission lines 2. Specifically, the abrasion-resistant flexible sheet 10 comprises a coating portion 13 and two overlapping portions 14. The coating portion 13 is completely adhered to the outer surfaces 21 of the transmission lines 2 by the adhesive 12, and the gas within the accommodating space S is completely discharged. In a practical implementation, the outer surfaces 21 of the transmission lines 2 may be coated by the coating portion 13 first, and then the gas between the abrasion-resistant flexible film 1 and the transmission lines 2 may be discharged so that the coating portion 13 can be fully bonded to outer surfaces 21 of the transmission lines 2. The overlapping portions 14 result from two edge portions of the abrasion-resistant flexible sheet 10 extending outward along the width direction W of said transmission lines 2. The two overlapping portions 14 are adhesively fixed to each other and overlapped with each other. Optionally, an inner surface of the overlapping portion 14 is adhered to an inner surface of the other overlapping portion 14 by the adhesive 12. However, the present invention is not limited to this. An inner surface of the overlapping portion 14 may be adhered to an outer surface of the other overlapping portion 14.

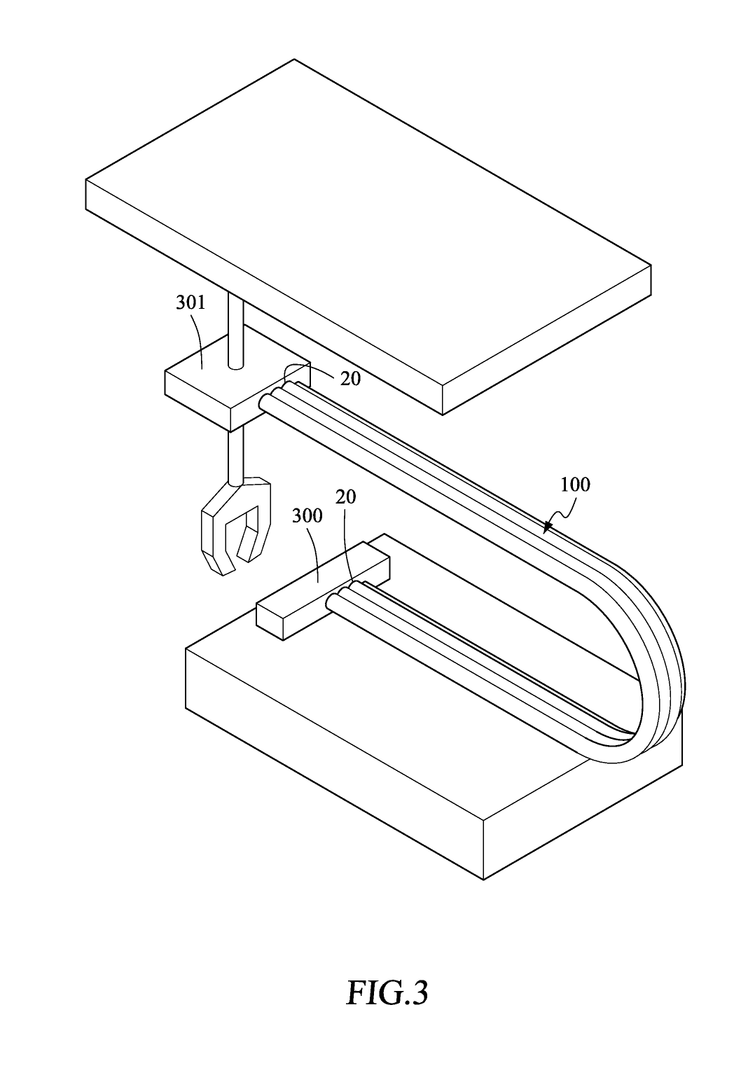

Referring to FIG. 3 in conjunction with FIGS. 1 and 2, the flexible transmission line assembly 100 is connected between a control means 300 and a robotic arm means 301 (as shown in FIG. 3) that are movable relative to each other. The transmission lines 2 transmit a power signal and a control signal generated by the control means 300 to the robotic arm means 301. The robotic arm means 301 receives the power signal and the control signal and performs a reciprocating movement in a horizontal direction. The three transmission lines 2 are towed simultaneously by the robotic arm means 301 because of the flexibility of the abrasion-resistant flexible film 1. The abrasion-resistant flexible film 1 is tightly coated on the three transmission lines s. And consequently, there will not be collision and abrasive action occurred between the abrasion-resistant flexible film 1 and the three transmission lines 2 during the reciprocating movement. Therefore, the flexible transmission line assembly 100 hardly produces noise and dust pollution.

Referring to FIG. 4, a flexible transmission line assembly 100a and the flexible transmission line assembly 100 are roughly the same according to another embodiment of the present invention. The similar details of the embodiment will thus be omitted herein. The difference is that the abrasion-resistant flexible film 1a consists of two abrasion-resistant flexible sheets 10a which respectively coats on the outer surfaces 21 of the plurality of transmission lines 2a. Each abrasion-resistant flexible sheet 10a is formed with two overlapping portions 14a-14b on two edge portions of abrasion-resistant flexible sheet 10a as being extended outward along the width direction W of the transmission lines 2a. The inner surface of the overlapping portions 14a/14b of one abrasion-resistant flexible sheet 10a is adhered to the inner surface of the overlapping portions 14b/14a of the other abrasion-resistant flexible sheet 10a.

The coating portion 13 of the abrasion-resistant flexible sheets 10a is partially adhered to the outer surfaces 21 of the plurality of transmission lines 2a by the adhesive 12, in a way that a gap I is formed in a non-bonded portion between the coating portion 13 and the plurality of transmission lines 2a.

The above describes the preferred possible embodiments of the present invention, which are not intended to limit the scope of the present invention, so the equivalent structural changes according to the above specification and the accompanied claims of the present invention are considered to be included within the scope of the present invention.

What is claimed is:

1. A flexible transmission line assembly, which is connected between two relatively moving means that are movable relative to each other, the flexible transmission line assembly comprising:
an abrasion-resistant flexible film whose inner surface is surrounded to form a receiving space, and is provided with an adhesive; and
a plurality of transmission lines provided within the receiving space in a way each transmission line is adjacent to one another in a single row in width directions of the transmission lines, and the adjacent transmission lines being closely contacted with each other, the plurality of transmission lines being adhered with the inner surface of the abrasion-resistant flexible film by means of the adhesive, and a connecting element formed respectively at the two ends of said plurality of transmission lines in a longitudinal direction thereof.

2. The flexible transmission line assembly of claim 1, wherein the abrasion-resistant flexible film is one abrasion-resistant flexible sheet wrapping over outer surfaces of the plurality of transmission lines.

3. The flexible transmission line assembly of claim 2, wherein both edge portions of the abrasion-resistant flexible film is formed with two overlapping portions which respectively extend along the width direction of the abrasion resistant flexible film, and the two overlapping portions are adhered with each other.

4. The flexible transmission line assembly of claim 1, wherein the abrasion-resistant flexible film is provided as two abrasion-resistant flexible sheets wrapping over outer surfaces of the plurality of transmission lines.

5. The flexible transmission line assembly of claim 4, wherein two edge portions of each abrasion-resistant flexible sheet are formed with two overlapping portions extending along the width direction of the abrasion resistant flexible sheets, and the overlapping portions of one abrasion-resistant flexible sheet is adhered to the overlapping portions of another abrasion-resistant flexible sheet.

6. The flexible transmission line assembly of claim 5, wherein an inner surface of the overlapping portion is adhered to an inner surface of another overlapped portion by the adhesive.

7. The flexible transmission line assembly of claim 1, wherein the abrasion-resistant flexible film is provided with a wrapping portion which is partially adhered to an outer surface of the plurality of transmission lines in the manner that a space is formed between the wrapping portion and a portion of the plurality of transmission lines which is not adhered.

8. The flexible transmission line assembly of claim 1, wherein the abrasion-resistant flexible film is provided with a wrapping portion which fully adheres to an outer surface of the plural transmission lines to completely expel gas within the receiving space.

9. The flexible transmission line assembly of in claim 1, wherein the abrasion-resistant flexible film is a PU (Poly Urethane) abrasion-resistant flexible film, a TPFE (Poly Tetra Flouro Ethene) abrasion-resistant flexible film, or a PET (Polyethylene terephthalate) abrasion-resistant flexible film.

10. The flexible transmission line assembly of claim 1, wherein the adhesive is a silicon adhesive or an acrylic adhesive.

11. The flexible transmission line assembly of claim 3, wherein an inner surface of the overlapping portion is adhered to an inner surface of another overlapped portion by the adhesive.
